(19) United States
(12) Patent Application Publication
(10) Pub. No.: US 2015/0206098 A1
(43) Pub. Date: Jul. 23, 2015

(54) SYSTEM AND METHOD OF LOADING PLANT SPECIES FOR TRANSPORTATION

(71) Applicant: GENESISTEMS, INC., Honeoye Falls, NY (US)

(72) Inventors: Eric Richard Muench, Honeoye Falls, NY (US); James David Palladino, Liverpool, NY (US)

(21) Appl. No.: 14/456,431

(22) Filed: Aug. 11, 2014

Related U.S. Application Data
(60) Provisional application No. 61/928,715, filed on Jan. 17, 2014.

(51) Int. Cl. G06Q 10/08

(52) U.S. Cl. CPC G06Q 10/0835; G06Q 10/087

(57) ABSTRACT

A computer system, computer program product and method of optimizing the positioning of objects for transportation that includes a processor obtaining information describing at least one rack, where the rack includes one or more shelves and determining load parameters related to the rack. The processor also obtains order information that includes data describing objects in an order, at least in part from a memory resource. Based on obtaining the order information, the processor creates one or more buffer elements. Each buffer element represents a quantity of objects of the plurality of objects that can fit on a given shelf. Based on the load parameters, the processor analyzes each shelf and assigns a shelf type variable to each shelf and the processor determines the amount of objects that can fit on the individual. Based on the shelf type variable, the processor assigns shelves to each buffer element.

### CROSS REFERENCE TO RELATED APPLICATION

The present invention claims priority from U.S. provisional patent application No. 61/928,715, filed Jan. 17, 2014, which is hereby incorporated herein by reference in its entirety.

### FIELD OF INVENTION

The invention relates generally to systems and methods for dynamic load planning in the wholesale plant industry and to a system and method for determining the optimum placement of shelves, and plants on shelves, to fill the transportation racks used to transport plants.

### BACKGROUND OF INVENTION

The wholesale plant industry generally transports various plant products from their production fields to the retail outlets by truck or common carrier on rolling racks sized to fit efficiently in a truck. These racks can utilize adjustable shelves for variable heights between shelves to allow various height plants to be placed on the shelves.

Using present methods, when an order is placed for a plant delivery, the number of racks needed to accommodate the order is estimated and this route planning allows extra space for additional racks per truck than might be needed to load the orders on a truck. Plants are placed on the racks without any knowledge of all the items involved in the shipment, so space in the vehicle and space in the racks is not used efficiently. Rather, often, more racks and more space are utilized than estimated or necessary. Thus, currently, when loading plants for transport on rolling racks, sales personnel cannot anticipate whether loaded racks will depart with empty spaces that could have housed more product.

By identifying these empty spaces in a rack configuration in advance, wholesalers could sell additional products to fill in any remaining space on a partially filled rack. If the exact number of racks for a shipment, rather than just an estimate, were known know before the truck routing and loading is started, a supplier could more efficiently and accurately plan its deliveries and routes without having to allow extra unused space on the trucks to account for possible loading issues.

### SUMMARY OF INVENTION

Shortcomings of the prior art are overcome and additional advantages are provided through the provision of a method for improving communication between a patient and a provider, the method includes: obtaining, by a processor, information describing at least one rack, wherein the rack comprises one or more shelves and determining load parameters related to the at least one rack; obtaining, by the processor, order information comprising data describing a plurality of objects that comprise an order, wherein the processor obtains at least a portion of the data from a memory resource; based on obtaining the order information, creating, by the processor, one or more buffer elements, wherein each buffer element of the one or more buffer elements represents a quantity of objects of the plurality of objects that can fit on a given shelf; based on the load parameters, analyzing, by the processor, each shelf of the one or more shelves and assigning a shelf type variable to each shelf, wherein for each individual shelf of the one or more shelves, the shelf type variable represents an amount of objects that can fit on the individual shelf and positioning requirements for the individual shelf when placed on the at least one rack, wherein the processor determines the amount of objects that can fit on the individual shelf based on whether any objects are on the individual shelf; and based on the shelf type variable, assigning, by the processor, at least one shelf of the one or more shelves to each buffer element of the one or more buffer elements.

Embodiments of the present invention include a computer system, method, and computer program product that analyze the characteristics and quantities of objects, including but not limited to the number of plants in a customer's order, and determine the at least one optimal arrangement of racks for use in transporting the objects in a given space, for the shelves on the racks, and/or for the objects on the shelves.

An aspect of an embodiment of the present technique determines an optimized layout for objects, including but not limited to, an arrangement of plants on shelves, Shelves on Racks, and/or Racks for an order.

An aspect of an embodiment of the present invention configures optimized arrangements to accommodate each order.

Upon determining an optimized arrangement, an aspect of an embodiment of the present invention communicates and/or displays to a user, any unused transportation space and, in some embodiments of the present invention, so that an operator can anticipate the empty spaces and suggest additional objects, e.g. plants, that can be added to an order and transported in the unused space.

In determining an optimized arrangement for objects in given spaces, including but not limited to plants on configurable racks, embodiments of the present invention utilize data including, but not limited to, limitations of the shelf placement for the racks being used, the plant needs, the target filling percentages for the users.

Embodiments of the present invention communicate the optimized arrangement to users by generating reports, including but not limited to, a Rack Loading Form. A Rack Loading Form includes instructions for each rack within a determined configuration, noting the number if shelves and the placement and contents, for each rack in a shipment.

Computer systems, computer program products and methods relating to one or more aspects of the technique are also described and may be claimed herein. Further, services relating to one or more aspects of the technique are also described and may be claimed herein.

Additional features are realized through the techniques of the present invention. Other embodiments and aspects of the invention are described in detail herein and are considered a part of the claimed invention.

### BRIEF DESCRIPTION OF DRAWINGS

The foregoing and objects, features, and advantages of one or more aspects of the invention are apparent from the following detailed description taken in conjunction with the accompanying drawings in which:

FIG. 1 depicts one example of an aspect a computing environment used to execute one or more aspects of an embodiment of the present invention;

FIG. 2 depicts one embodiment of a single processor computing environment to incorporate and use one or more aspects of the present invention; and

FIG. 3 depicts one embodiment of a computer program product incorporating one or more aspects of the present invention.

FIG. 4 depicts logic employed in computer program instructions incorporating one or more aspects of the present invention.

FIG. 5 depicts reports generated by an embodiment of the present invention to assist in loading objects into a given space.

FIGS. 6a-6e depict elements of a loading configuration in an aspect of the present invention.

FIG. 7 depicts a workflow of an embodiment of the present invention.

FIG. 8 depicts a workflow of an embodiment of the present invention.

### DETAILED DESCRIPTION OF THE INVENTION

Embodiments of the present invention determine an optimized loading plan to load select objects into a given space by executing methods that include selecting objects, including but not limited to, plants, from an inventory, determine positioning and/or placement for the selected objects in a loading area to increase efficiency in a loading process, determining the configuration of shelving on racks to maximize the load capacity, and generating all documentation associated with the loading process.

Embodiments of the present invention can be utilized to determine an optimized loading plan in at least the following exemplary situations: 1) loading of a given truck with objects (plants) by a given user; and 2) loading of multiple orders in the same space. In the first example, embodiments of the present invention display an optimized loading plan and suggest order modifications to the purchaser to increase efficiency and introduce cost benefits.

In an embodiment of the present invention, the processor executing code obtains orders to be processed on a given day, or over a predetermined period of time, and combine all products with matching parameters, for example, plants of the same type into a report of Plants and Field Racks needed, so the field workers can retrieve the Total number of a Plants needed (Dig or collect them), and place them on field racks with no mixing of products on them. These are brought from the field into the Staging Area as “Today's Inventory” from which the individual plants for an order are acquired from. Thus one process creates an aggregate number of plants to be brought in for today's orders and another process identifies the specific plants and loading for an order. When done all the requested plants will end up on all the processed orders with no overage or shortage, i.e., the Field racks will be empty and all the Order Racks will be full.

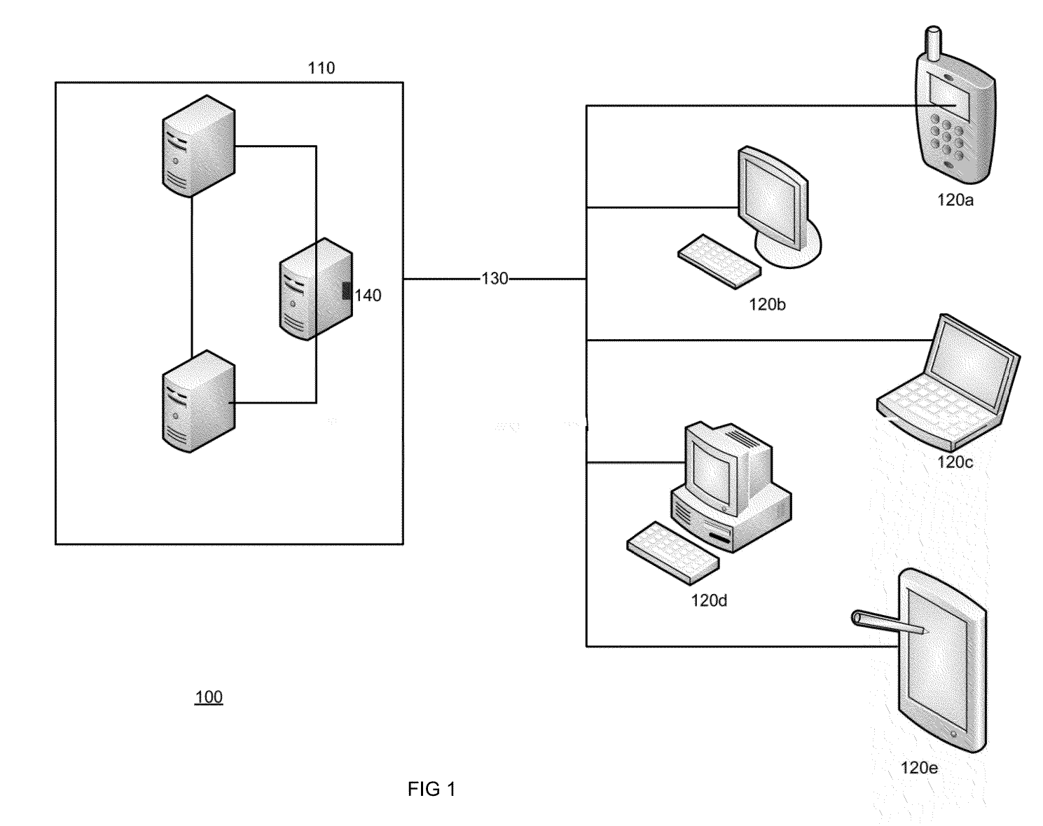

FIG. 1 is a computing environment 100 used to execute one or more aspects of an embodiment of the present invention. In this embodiment, a computer system 110, which can include a cloud and/or an enterprise system, is accessible by one or more terminals 120a-120e. Computer system 110 can also be a single computer resource. The terminals access the one or more resources of the computer system 110 via a network connection 130, including but not limited to a LAN, a WLAN, and/or an Internet connection.

In this embodiment, computer system 110 contains one or more servers, such as web or application servers, that serve content to the terminals 120a-120e over the network connection 130.

In this embodiment, each of the terminals 120a-120e includes at least one processor (not pictured) and at least one memory resource (not pictured). The terminals 120a-120e are capable of executing a client program on the terminals 120a-120e, including but not limited to a thin client, proprietary client, or a web browser, which users of the terminals 120a-10e utilize to interact with a client application 140 executed on one or more resources of the computer system 110. In this embodiment, the client application 140, which is comprised of computer readable program code, is depicted as residing on one of the resources of the computer system 110. The terms “computer readable program code” and software are used interchangeably and both refer to logic executed by processing circuits on computer resources.

In further embodiments of the present invention, the client application 140 is installed on one or more resources of the computer system 110 and/or one or more computer resources accessible to one or more resources of the computer system 110.

An embodiment of the present invention also includes a computer program product executed by a processor on one or more computers. The software utilized can be executed entirely by a single computer resource without any third party software components.

A computer system practicing an aspect of an embodiment of the present invention may also accept data inputs from a properly configured web page VIA SOAP protocols.

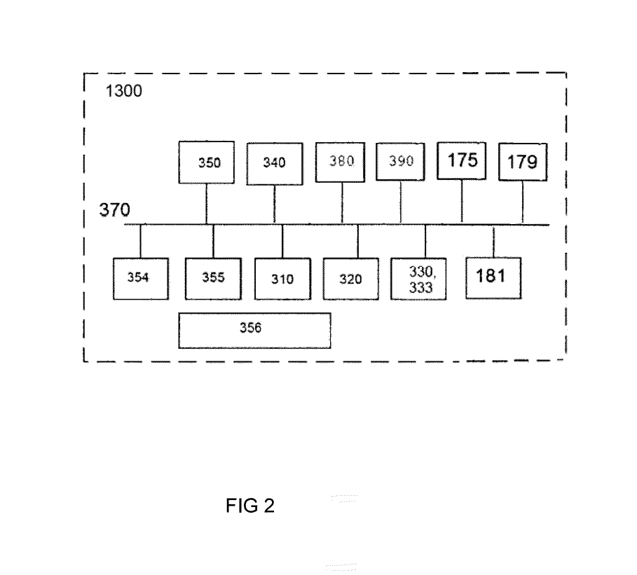

FIG. 2 illustrates a block diagram of a resource 1300 in computer system 110 and/or terminal 120a-120b, which is part of the technical architecture of certain embodiments of the technique. The resource 1300 may include a circuitry 370 that may in certain embodiments include a microprocessor 354. The computer system 1300 may also include a memory 355 (e.g., a volatile memory device), and storage 181. The storage 181 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 355 may comprise an internal storage device, an attached storage device and/or a network accessible storage device. The system 1300 may include a program logic 330 including code 333 that may be loaded into the memory 355 and executed by the microprocessor 356 or circuitry 370.

In certain embodiments, the program logic 330 including code 333 may be stored in the storage 181, or memory 355. In certain other embodiments, the program logic 333 may be implemented in the circuitry 370. Therefore, while FIG. 2 shows the program logic 333 separately from the other elements, the program logic 333 may be implemented in the memory 355 and/or the circuitry 370.

Using the processing resources of a resource 1300 to execute software, computer-readable code or instructions, does not limit where this code is can be stored.

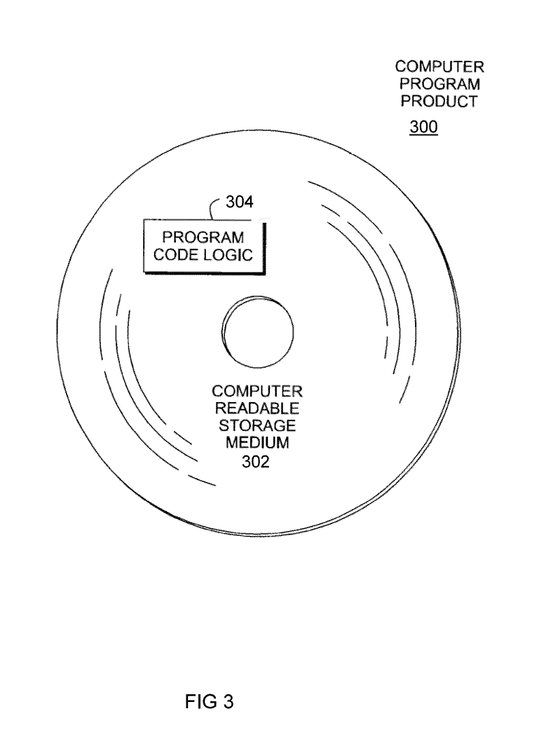

Referring to FIG. 3, in one example, a computer program product 300 includes, for instance, one or more non-transitory computer readable storage media 302 to store computer readable program code means or logic 304 thereon to provide and facilitate one or more aspects of the technique.

As will be appreciated by one skilled in the art, aspects of the technique may be embodied as a system, method or computer program product. Accordingly, aspects of the technique may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technique may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the technique may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technique are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions, also referred to as computer program code, may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technique. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the technique may be provided, offered, deployed, managed, serviced, etc. by a service provider who offers management of customer environments. For instance, the service provider can create, maintain, support, etc. computer code and/or a computer infrastructure that performs one or more aspects of the technique for one or more customers. In return, the service provider may receive payment from the customer under a subscription and/or fee agreement, as examples. Additionally or alternatively, the service provider may receive payment from the sale of advertising content to one or more third parties.

In one aspect of the technique, an application may be deployed for performing one or more aspects of the technique. As one example, the deploying of an application comprises providing computer infrastructure operable to perform one or more aspects of the technique.

As a further aspect of the technique, a computing infrastructure may be deployed comprising integrating computer readable code into a computing system, in which the code in combination with the computing system is capable of performing one or more aspects of the technique. As a further aspect of the technique, the system can operate in a pier to pier mode where certain system resources, including but not limited to, one or more databases, is/are shared, but the program code executable by one or more processors is loaded locally on each computer (workstation).

As yet a further aspect of the technique, a process for integrating computing infrastructure comprising integrating computer readable code into a computer system may be provided. The computer system comprises a computer readable medium, in which the computer medium comprises one or more aspects of the technique. The code in combination with the computer system is capable of performing one or more aspects of the technique.

Further, other types of computing environments can benefit from one or more aspects of the technique. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the technique, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instructions and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

Returning to FIG. 1, in an embodiment of the present invention, client application 140 is installed on one or more resources of the computer system 110 and/or one or more computer resources accessible to one or more resources of the computer system 110. This exemplary embodiment is utilized merely to illustrate an embodiment of the present technique. The computer program code utilized in aspects of the present technique to perform a method, when executed by a processor, internal or external to a computer system 110, can be housed on a memory device that can be either internal or external to a physical machine (or multiple physical machines) executing the computer program code.

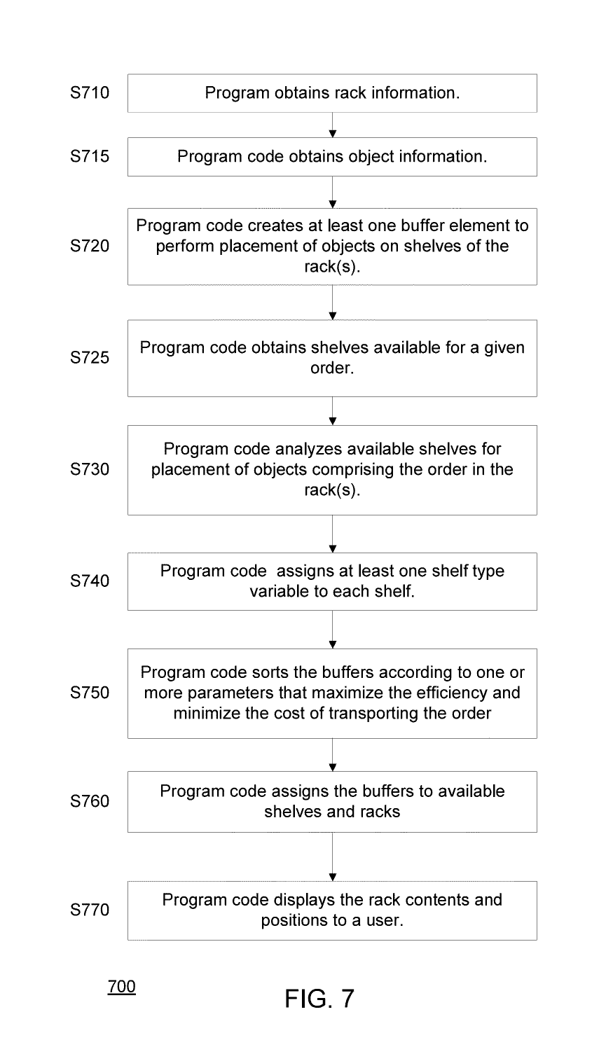

In an embodiment of the present invention, one or more processors in a computer system 110 executes computer code that processes a given order for objects, for example, plants, and generates an optimized loading plan for the order (or orders). A workflow 700 of an embodiment the present invention is depicted in FIG. 7.

In this embodiment, for each order processed, the computer program code executed by a processor obtains rack information (S710) and object (e.g., plant) information (S715). The object information describes a plurality of objects that are included in an order. In an embodiment of the present invention, the rack information includes information related to the type of number of shelves available of each rack described in the rack information. The information obtained describing the rack and any shelves on the rack can be understood as parameters relating both to the rack as well as to the shelves.

In an embodiment of the present invention, rack information includes, but is not limited to, rack height, load height, maximum shelf height/depth, minimum shelf space, ledge positions, percent to mix, shelf utilization goal, and/or the number of plants per shelf and/or per tray (if multiple trays per shelf). Upon obtaining rack information, the processor executes the computer code to determine load parameters.

In an embodiment of the present invention, plant (object) information includes, but is not limited to, whether single or double shelves are needed for each plant, whether any plant requires special placement (for example, a shade plant should not be placed on a top shelf), the dimensions of each plant, the maximum plants per shelf of this plant allowed, the descriptions of each plant, and quantities in stock and height of plants in that location. In an embodiment of the present invention, the processor can execute computer code to adjust the retail price of the shipment of items based on factors noted in the plant data that conforms with predefined business rules.

In an embodiment of the present invention, the processor utilizes information saved in a memory and/or a file, in order to obtain plant data. In one embodiment of the present invention, plant data is separated into a group of related files containing required parameters for the plants contained. In this embodiment, for each order, the processor utilizes the computer code to access one or more of a Plant Size File to determine if single or double shelves are needed for this plant, a Plant Name File to check if this is a shade plant, preventing it from top shelf placement, a Product File for dimensions and descriptions, a Product Locations file for quantities in stock and height of plants in that location. In an embodiment of the present invention, optionally when retail price is validated and updated based on these files, the new value is saved back into the order line item record and saved on a memory device accessible to the processor via a communications network connection.

In an embodiment of the present invention, once the processor has obtained rack information and plant information, the processor executes computer code to create a buffer element to perform all placement processes (S720). Buffer size can be adjusted to hold any number of line items as it is dynamically built. For example, if a line item in a given order contains more plants than will fit on a single shelf, multiple buffer elements will be added to the buffer for that line item. Thus, in the given example, if a shelf holds 20 plants of one product, and 100 plants are ordered, the processor creates 5 buffer records with 20 plants on each shelf.

The program code also obtains information regarding the shelves available for the given order (S725). Utilizing the rack information, the processor executing computer program code analyzes the shelves available for the given order to optimize placement of the given order in the racks described by the information obtained (S730). In an embodiment of the present technique, to analyze the one or more shelves described in the rack information, the processor executed computer code that performs at least one of the following: separates full shelves from half shelves and partial shelves to produce efficient placement of shelves on a rack, from multiple shelves that complement each other (50%+50%, 25%+75%, etc.), places shade shelves lower on the rack. In an embodiment of the present invention, the processor executing the code assigns at least one shelf type variable based on this analysis (S740).

As aforementioned, once buffers are established, the processor executing the computer program code sorts the buffers according to one or more parameters that maximize the efficiency and minimize the cost of transporting the order (S750). In an embodiment of the present invention, these parameters can be accessed from a memory accessible to a processor executing computer code and these parameters may include, but are not limited to, Source Type (in some embodiments allows up to 9 different plant supplier sources), Shelf Type (assigned based on the aforementioned analysis), whether shade is required, a Multi-Flag parameter representing whether given objects (plants) are paired or not, a Multi-shelf parameter, which represents complimentary shelves, a Shelf Number (assigned to distinguish shelves on a rack), Height (the height of each plant on shelf), Single/Double (double shelves are used for heavy plants to prevent breaking during transportation), and/or Product # (the number assigned to the products). In an embodiment of the present invention, the parameters may include specific requirements that may affect the overall efficiency of the resulting order for transport. In an embodiment of the present invention, program code determines an efficient arrangement in view of any such additional requirement. For example, a parameter may require that the method prioritize maximize load or locate similar items together to ease unloading. When a requirement such as ease of unloading is a parameter, the program code may sort the buffers to maximize the efficiency and minimize the cost of transporting the order, in view of this parameter. In one example, more shelves may be utilized to enable ease of unloading than would be utilized in the absence of this parameter.

Different sort orders can be predefined for different purposes. Below are seven exemplary pre-defined sort order that are utilized by a processor executing computer code to sort the buffers: 1) Source Type/Shelf Type/Shade/Multi-Flag/Multi-Shelf/Shelf, Height/Single/Prod; 2) Source/Type/Shade/Percent-Utilization/Height/Product; 3) Source/Shade/Multi-Flag/Multi-Shelf/Shelf Number/Max Height/Single/Product; 4) Source/Multi-shelf/Shelf Type/Single or Double/Size; 5) Source/Rack/Rack Sequence/Multi-Flag/multi-shelf/Shelf (with reverse and other options on each); 6) Source/Rack/Shelf; 7) Source/Shelf/Single/Product.

In some embodiments where Source is a parameter utilized to sort the buffers, for each Source, the processor executing computer code selects a low and high range of shelf. In this embodiment, each Source is processed separately from others to separate racks and plants from the low to high sequence for each Source.

In an embodiment of the present invention, the program code assigns the buffers to available shelves and racks (S760). The number of buffers may not match the number of shelves and embodiments of the present technique can combine shelves and assign multiple shelves to buffers. In one aspect, multiple shelves are assigned by the computer program by obtaining all half and partial shelves and determining the multi-shelf numbers which pair complimentary shelves. To aid in assigning buffers to these shelves, the processor assigns all shelves that combine into a single shelf the same identifier, for example, the same multi-Shelf Number. In an embodiment of the present invention, for each combined shelf, two identifiers are set, one noting that the shelf is a combination of more than one shelf, and the other, differentiating the grouped shelves as a shelf for buffer for sorting.

As part of sorting, i.e., organizing the aforementioned buffers, shelves and racks are ultimately assigned to the buffers by the processor executing computer program code. For example, a processor sorts buffers by type to prepare for assigning Shelves, and assigns shelf numbers to the buffers. In an embodiment of the present invention, the buffers are stored in a Sort Buffer array that is generated by the computer program code and stored in memory accessible to the processor executing the code. In assigning shelves, in embodiments of the present invention, the code assigns partial shelves (half and partial) and full shelves in separate passes to assign the shelves to appropriate racks. In an embodiment of the present invention, the code utilizes identifiers to designate the different shelves, for example, F (Full Shelf), H (Half Shelf, paired into one shelf for each two), L (Partial Shelves, combined to form single shelf for more than one), K (partial shelf, but not combined as multiple shelf). In this embodiment, the processor executing code can temporarily change the shelf type for sorting purposes to distinguish multi-shelves.

In embodiments of the present invention, the processor utilizes the computer program code to determine the actual shelf numbers for each source, to sort the shelf buffer to position shelves to be placed on racks, and to determine the actual shelf numbers for each source to be processed.

The present technique not only assigns buffers to shelves, it also assigns shelves to racks. In an embodiment of the technique, each Source is selected separately to produce separate racks. In order to “build” the racks from the available shelves, the computer code finds the maximum height of plants on each shelf, assigns the next rack number for this source and sets up rack variables to default values, and determines the best layout for a rack with open shelves.

In an embodiment of the present technique, the computer program code determines the best layouts by analyzing each shelf placed to whether that shelf best fits the certain requirements, including but not limited to, shade positions, top shelf position, and/or maximum height allowed for rack. In an embodiment of the present technique, the processor also executes computer code to determine where the top of the shelf would reach by considering where the last shelf ended and where the next shelf position is and taking into account single or double shelf heights.

In embodiments of the present invention, determining the best layout for a rack with open shelves can include the execution of certain subroutines in computer program code by the processor. For example, the processor can executed a routine to place the shelf and record values which includes, but is not limited to, determining if a given shelf is best to either come closest to the top shelf position or give the highest allowable height above the top shelf position if it is the top shelf. Another subroutine enables a processor to set all rack variable values when determining the assignments, including, but not limited to, shelf positions, shelf sequence on rack, positions assigned and open.

In embodiments of the present invention where shelves comprise multiple items, to determine the best layout for a rack with open shelves by placing shelves and recording values, the processor can execute code to assign all related multi-shelves to a given position. In an embodiment of the present invention, once a shelf is assigned, there could be multiple shelves that are physically placed on the same shelf that need placement. For instance if there are two half shelves of different plants that were matched as Multi-Shelves, this will place the two as one shelf on the rack. To place shelves and record values, some embodiments of the invention execute computer program code to set the current top position on the rack and once top is reached, set a variable to a given value, for example, 1. If the variable to set to the predetermined value, the code processes the shelves to set all sort buffer properties, including but not limited to, shelf, shelf sequence (position on rack from bottom), percent utilized, top position, number of shelf sequences, the rack number assigned.

The code may also capture position data of the rack on each shelf including, but not limited to, the position of each shelf on the rack, the bottom and top positions of each shelf, the top height reached on the rack so far, that the start position for the next shelf is one will fit. The processor can execute code to updates the sorted buffers with the values assigned, including but not limited to, rack number, top position, and/or rack shelf sequence.

Based on determining the rack contents and positions, embodiment of the present invention can display the rack contents and positions to a user through a display communicatively coupled to the processor in a computer system (S770). Further embodiments of the present invention utilize methods known in the art to notify a user of the rack contents and positions utilizing, for example, email, text message, etc.

In determining and communicating the final configuration for the racks, the plants (objects) on the shelves and the shelves in the racks, in embodiments of the technique, the processor executes computer code to set the rack sequences for position, assign final shelf numbers based on the specific rack where placed, to sort with type 6 (explained above) for final rack display, to display the final grid to the operator, to write the sort buffer into files. In one embodiment of the present invention, the processor writes the sort buffer into three files: 1) Oerk1, contains information concerning the number of racks and the load; 2) Oerk2, which contains information about the each rack on the load; and 3) Oerk3, which contains information about each shelf sequence on the rack. These file names are offered as examples of files utilized in an embodiment of the present invention as any number and names of files can be utilized in the disclosed technique.

As aforementioned, embodiments of the present invention can be utilized to produce instructions for loading a set of objects into a given space, for example, plants into a truck. In certain embodiments, the processor can execute computer code to instruct components of a computer system to generate and print the Rack Assembly Sheets. One example of a Rack Assembly Sheet is generated by saving barcode records, which are printed on demand. Embodiments of the present inventions, the processor can also execute code that instructs components of a computer system, such as a printer, to print a summary sheet for the truck driver, including printing barcodes on the sheet.

In embodiments of the present invention, when the technique builds a sort buffer, certain functionality can assist a user. For example, the processor can execute computer code to provide instant feedback to a user as to the number of shelves and racks filled. Embodiment of the present invention are capable of creating plans to for loading multiple orders on a truck load and generating the records associated with this loading plan. The invention can also be utilized to generate digging cards used to identify plants to be loaded from the field to the staging area to be later loaded on order racks.

Upon determining an optimized arrangement, an aspect of an embodiment of the present invention communicates and/or displays to a user, any unused transportation space. By assisting a vendor in anticipating excess space, a vendor can suggest additional objects, e.g. plants, that can be added to an order and transported in the unused space.

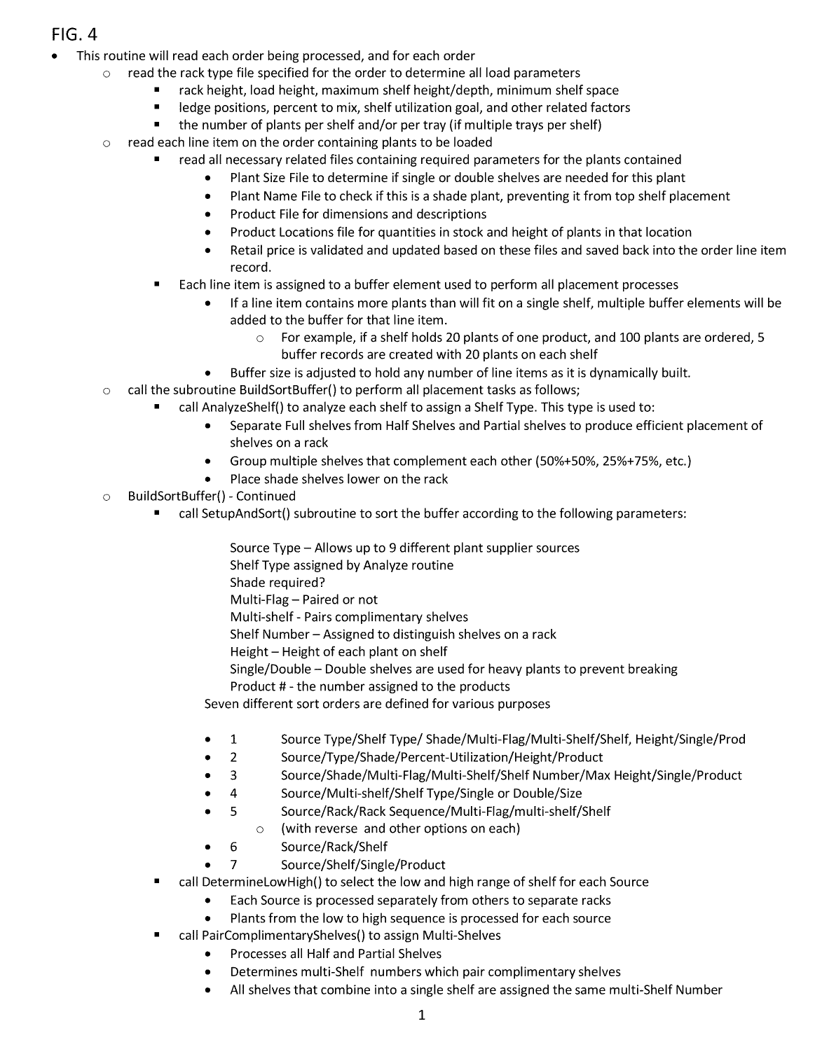

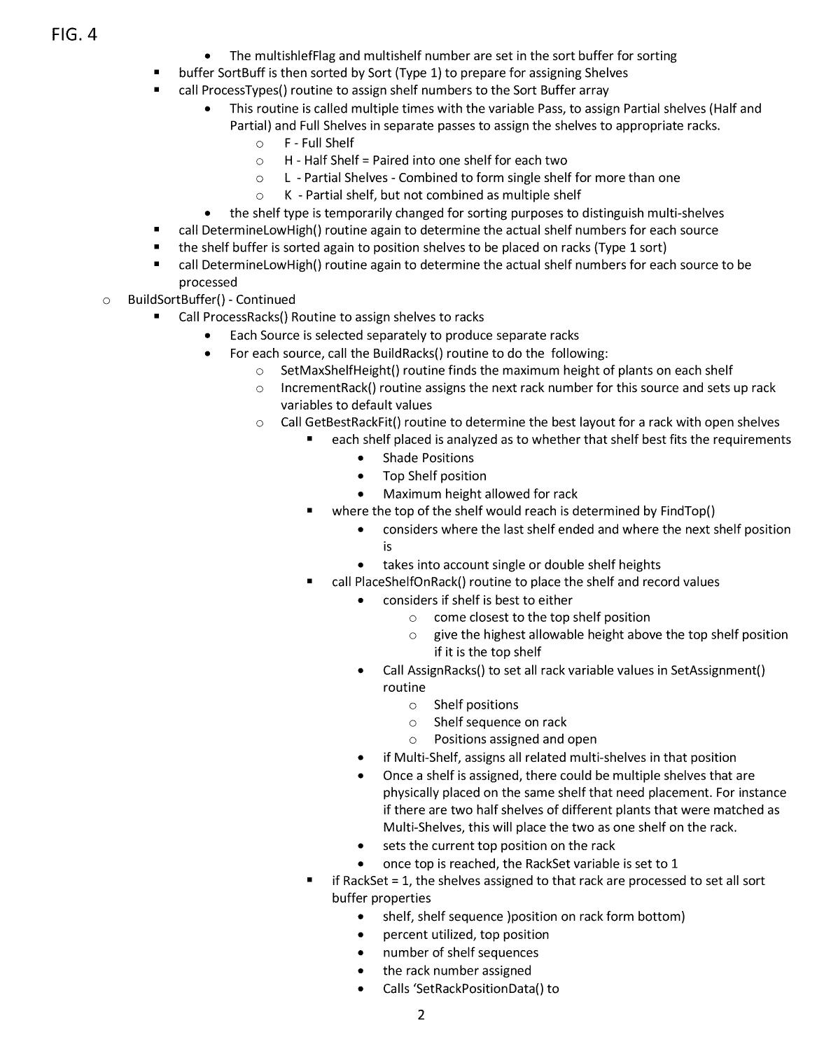

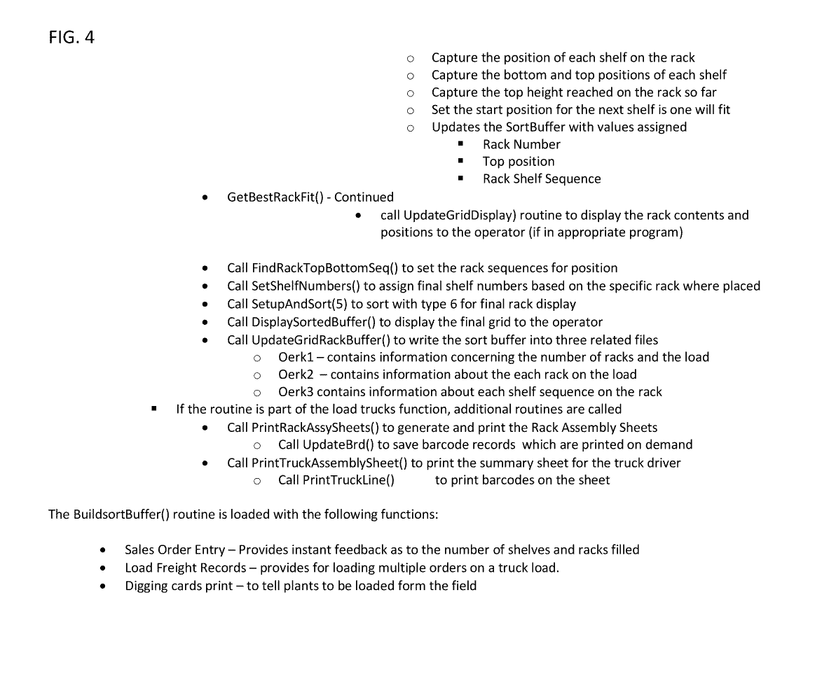

FIG. 4 is an example of logic that can be incorporated into computer program code utilized in embodiments of the present invention to perform aspects of the method described.

FIG. 5 is an example of reports generated by embodiments of the present invention to assist in configuring apparatus to load objects and loading the objects.

Referring to FIG. 5, reports instruct as to the locations of the plants and the configuration of the racks and shelves. For example, in FIG. 5, the “P” column refers to the position and instructs an individual loading plants on a split shelf which plants go on the left, “L,” and which go the right, “R.” Some reports include “C,” center directions if three products are on the shelf looking at the rack from the front.

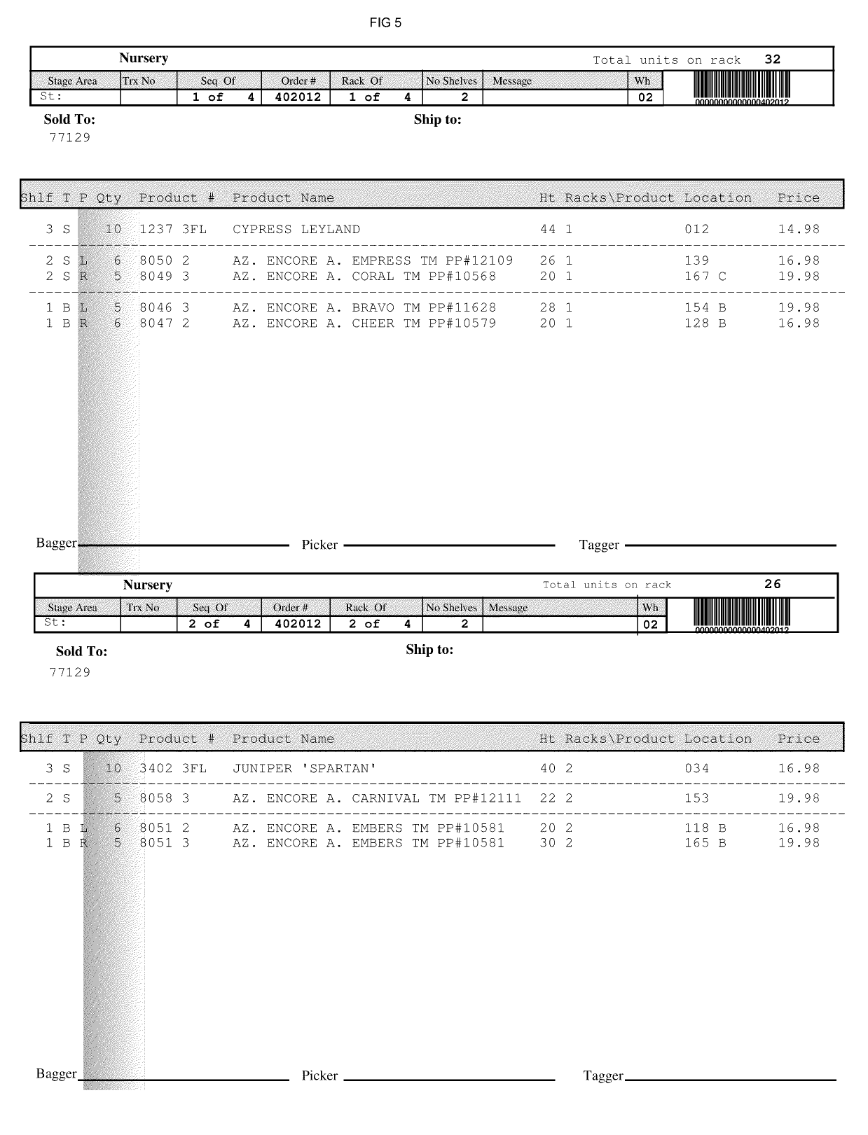

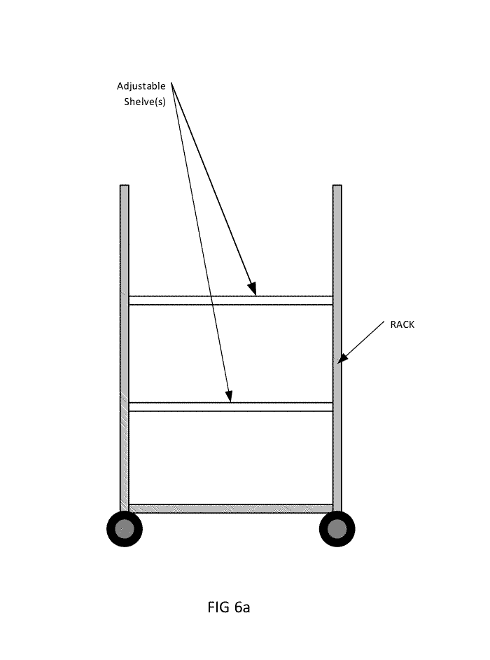

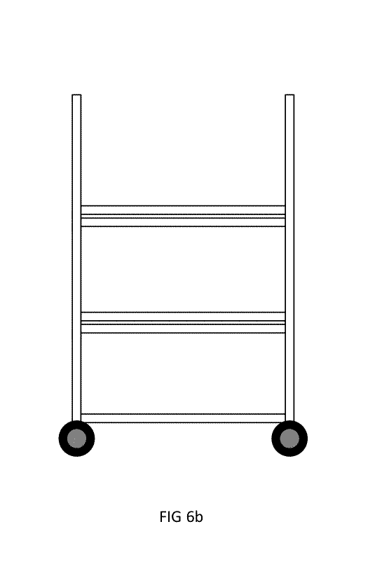

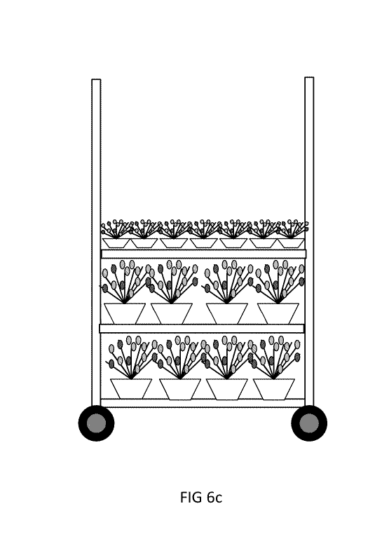

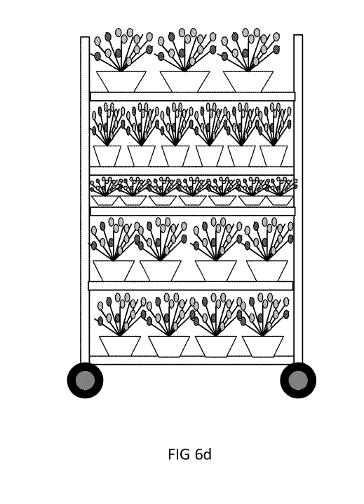

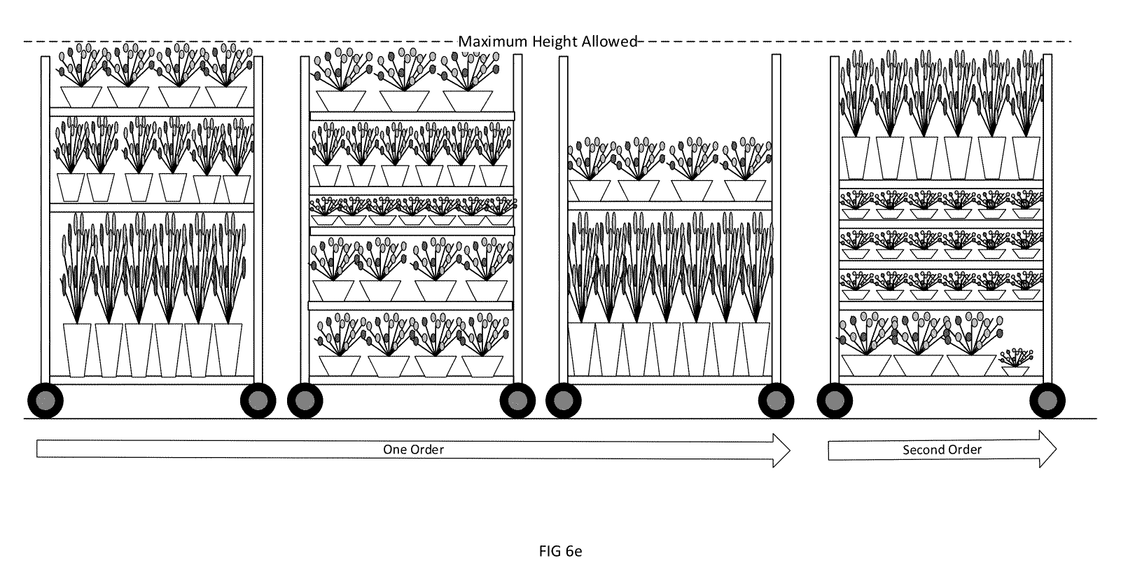

FIGS. 6a-6e are an example of the a rack loading process governed by an embodiment of the present invention. FIG. 6a is a single shelf and FIG. 6b is a double shelf, both unloaded. FIG. 6c shows the beginning of loading a rack in accordance with instructions generated by an embodiment of the technique. FIG. 6d depicts a loaded rack, while FIG. 6e depicts a completed order. Key is Finished Orders 1. That is the Lineup ready to go on the truck. Note the first two racks on the left under the #1 arrow are full and then there is a partially filled rack. That is the End of an order. In this example, the supplier did not sell the balance of the space. However, as explained earlier, embodiments of the invention identify this empty space in advance of loading so that the vendor could have the opportunity to market additional plants to complete the racks. The rack under Arrow 2 is the start of the next order going on that truck and is filled to the top. The key is none of the two orders have the same plants on the full racks—The system optimized the placement to fill it.

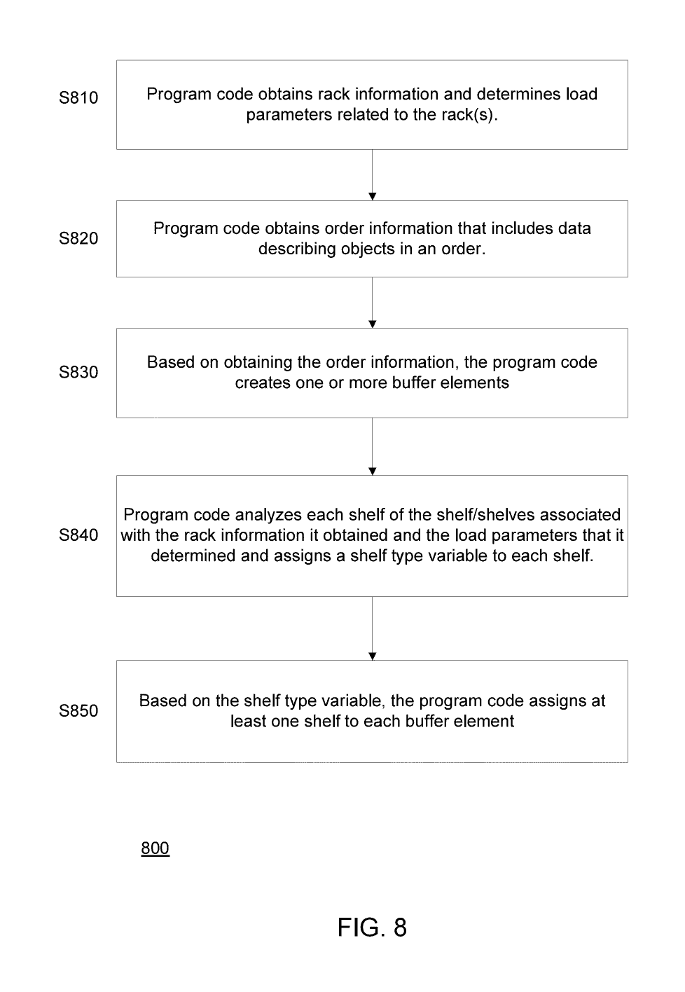

FIG. 8 is an example of a workflow 800 of an embodiment of the present invention. As seen in FIG. 8, the program code, executed by a processor on a computer system, such as that in FIG. 1, obtains information describing at least one rack. The rack(s) can accommodate one or more shelves and the information about the rack also includes information relating to associated shelves. The computer code obtains this rack information and determines load parameters related to the rack(s) (S810).

In addition to obtaining the rack information and obtaining, the program code also obtains information that includes data describing the objects in an order (S820). These objects can be plants and in this embodiment of the present invention, the program code obtains some of the information about the objects from a memory resource that is accessible to the processor executing the program code.

Based on obtaining the order information, the program code creates one or more buffer elements (S830). Each buffer element may represent a quantity of objects in the order that can fit on a given shelf.

Based on the load parameters, the program code analyzes each shelf of the one or more shelf associated with the rack information it obtained and the load parameters that it determined and assigns a shelf type variable to each shelf (S840). In this embodiment of the present invention, the shelf type variable represents both an amount of objects that can fit on the individual shelf to which it is assigned and positioning requirements for the individual shelf when placed on the at least one rack. An example of a positioning requirement would be that the shelf has shade plants, which would mean that the shelf should be located at the bottom of a rack when the rack is loaded with shelves. In an embodiment of the present invention, the program code determines the amount of objects that can fit on the individual shelf based on whether any objects are on the individual shelf, as all shelves may not be empty at a time when a given order is processed, other orders may have preceded it. Based on the shelf type variable, the program code assigns at least one shelf to each buffer element (S850). Because some of the shelves may already have some objects on them, as indicated by the shelf type variables associated with them, objects in an order may be split over more than one shelf. In this case, a buffer element is assigned to more than one shelf.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the descriptions below, if any, are intended to include any structure, material, or act for performing the function in combination with other elements as specifically noted. The description of the technique has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of optimizing the positioning of objects for transportation, comprising:
obtaining, by a processor, information describing at least one rack, wherein the rack comprises one or more shelves and determining load parameters related to the at least one rack;
obtaining, by the processor, order information comprising data describing a plurality of objects that comprise an order, wherein the processor obtains at least a portion of the data from a memory resource;
based on obtaining the order information, creating, by the processor, one or more buffer elements, wherein each buffer element of the one or more buffer elements represents a quantity of objects of the plurality of objects that can fit on a given shelf;
based on the load parameters, analyzing, by the processor, each shelf of the one or more shelves and assigning a shelf type variable to each shelf, wherein for each individual shelf of the one or more shelves, the shelf type variable represents an amount of objects that can fit on the individual shelf and positioning requirements for the individual shelf when placed on the at least one rack, wherein the processor determines the amount of objects that can fit on the individual shelf based on whether any objects are on the individual shelf; and
based on the shelf type variable, assigning, by the processor, at least one shelf of the one or more shelves to each buffer element of the one or more buffer elements.

2. The method of claim 1, wherein the information describing the at least one rack include at least one of: rack height, load height, maximum shelf height/depth, minimum shelf space, ledge position, percent to mix, shelf utilization goal, quantity of plants per shelf, quantity of plants per tray.

3. The method of claim 1, wherein data describing a plurality of objects wherein for each individual object data includes at least one of: whether single or double shelves are needed for the individual object, special placement instructions, dimensions, a maximum quantity of objects similar to the individual objects per shelf, descriptive data relating to the individual object, quantity of the individual object in a stock, height of any similar objects to the individual object in the stock.

4. The method of claim 1, wherein the amount of objects that can fit on the individual shelf for each shelf is represented as a full shelf, a partial shelf, or a half full shelf.

5. The method of claim 1, wherein the assigning of the at least one shelf of the one or more shelves to each buffer element of the one or more buffer elements is further based on at least one of: source type, shade requirement, requirement to pair the quantity of objects, height of the quantity of objects, weight of the quantity of objects, product identifier related to the quantity of objects.

6. The method of claim 1, wherein the assigning of the at least one shelf of the one or more shelves to each buffer element of the one or more buffer elements comprises selecting and implementing a sorting order, wherein the sorting order is one of a group of sorting orders saved on a memory resource.

7. The method of claim 5, wherein the assigning of the at least one shelf of the one or more shelves to each buffer element of the one or more buffer elements is further based on source type and the assigning comprises assigning a minimum height and a maximum height to each source type and assigning objects of one source type before assigning objects of a second source type.

8. The method of claim 4, wherein at least two shelves of the one or more shelves are assigned to one buffer element of the one or more buffer elements, wherein each shelf of the at least two shelves is not represented as a full shelf.

9. The method of claim 4, wherein the assigning of the at least one shelf of the one or more shelves to each buffer element of the one or more buffer elements comprises assigning any shelf of the one or more shelves that is represented by as a full shelf to a given buffer of the one or more buffer elements before assigning any shelf represented as a partial shelf, or as a half full shelf.

10. The method of claim 1, further comprising:
obtaining a maximum height for an object of the quantity of objects of the buffer element assigned to each shelf the one or more shelves; and
based on the maximum height and at least one shelf variable or rack variable, determining, by the processor, a placement for each shelf of the one or more shelves on the at least one rack, wherein the at least one shelf variable or rack variable is one of: shade position, top shelf position, or maximum height allowed for rack.

11. A computer system for optimizing the positioning of objects for transportation, the computer system comprising:
a memory; and
a processor in communications with the memory, wherein the computer system is configured to perform a method, the method comprising:
obtaining, by a processor, information describing at least one rack, wherein the rack comprises one or more shelves and determining load parameters related to the at least one rack;
obtaining, by the processor, order information comprising data describing a plurality of objects that comprise an order, wherein the processor obtains at least a portion of the data from a memory resource;
based on obtaining the order information, creating, by the processor, one or more buffer elements, wherein each buffer element of the one or more buffer elements represents a quantity of objects of the plurality of objects that can fit on a given shelf;
based on the load parameters, analyzing, by the processor, each shelf of the one or more shelves and assigning a shelf type variable to each shelf, wherein for each individual shelf of the one or more shelves, the shelf type variable represents an amount of objects that can fit on the individual shelf and positioning requirements for the individual shelf when placed on the at least one rack, wherein the processor determines the amount of objects that can fit on the individual shelf based on whether any objects are on the individual shelf; and
based on the shelf type variable, assigning, by the processor, at least one shelf of the one or more shelves to each buffer element of the one or more buffer elements.

12. The computer system of claim 11, wherein the amount of objects that can fit on the individual shelf for each shelf is represented as a full shelf, a partial shelf, or a half full shelf.

13. The computer system of claim 11, wherein the assigning of the at least one shelf of the one or more shelves to each buffer element of the one or more buffer elements is further based on at least one of: source type, shade requirement, requirement to pair the quantity of objects, height of the quantity of objects, weight of the quantity of objects, product identifier related to the quantity of objects.

14. The computer system of claim 11, wherein the assigning of the at least one shelf of the one or more shelves to each buffer element of the one or more buffer elements comprises selecting and implementing a sorting order, wherein the sorting order is one of a group of sorting orders saved on a memory resource.

15. The computer system of claim 13, wherein the assigning of the at least one shelf of the one or more shelves to each buffer element of the one or more buffer elements is further based on source type and the assigning comprises assigning a minimum height and a maximum height to each source type and assigning objects of one source type before assigning objects of a second source type.

16. The computer system of claim 12, wherein at least two shelves of the one or more shelves are assigned to one buffer element of the one or more buffer elements, wherein each shelf of the at least two shelves is not represented as a full shelf.

17. The computer system of claim 12, wherein the assigning of the at least one shelf of the one or more shelves to each buffer element of the one or more buffer elements comprises assigning any shelf of the one or more shelves that is represented by as a full shelf to a given buffer of the one or more buffer elements before assigning any shelf represented as a partial shelf, or as a half full shelf.

18. The computer system of claim 11, the method further comprising:
obtaining a maximum height for an object of the quantity of objects of the buffer element assigned to each shelf the one or more shelves; and
based on the maximum height and at least one shelf variable or rack variable, determining, by the processor, a placement for each shelf of the one or more shelves on the at least one rack, wherein the at least one shelf variable or rack variable is one of: shade position, top shelf position, or maximum height allowed for rack.

19. A computer program product for optimizing the positioning of objects for transportation, the computer program product comprising:
a computer readable storage medium readable by a processing circuit and storing instructions for execution by the processing circuit for performing a method comprising:
obtaining, by a processor, information describing at least one rack, wherein the rack comprises one or more shelves and determining load parameters related to the at least one rack;
obtaining, by the processor, order information comprising data describing a plurality of objects that comprise an order, wherein the processor obtains at least a portion of the data from a memory resource;
based on obtaining the order information, creating, by the processor, one or more buffer elements, wherein each buffer element of the one or more buffer elements represents a quantity of objects of the plurality of objects that can fit on a given shelf;
based on the load parameters, analyzing, by the processor, each shelf of the one or more shelves and assigning a shelf type variable to each shelf, wherein for each individual shelf of the one or more shelves, the shelf type variable represents an amount of objects that can fit on the individual shelf and positioning requirements for the individual shelf when placed on the at least one rack, wherein the processor determines the amount of objects that can fit on the individual shelf based on whether any objects are on the individual shelf; and
based on the shelf type variable, assigning, by the processor, at least one shelf of the one or more shelves to each buffer element of the one or more buffer elements.

20. The computer program product of claim 19, the method further comprising:
obtaining a maximum height for an object of the quantity of objects of the buffer element assigned to each shelf the one or more shelves; and
based on the maximum height and at least one shelf variable or rack variable, determining, by the processor, a placement for each shelf of the one or more shelves on the at least one rack, wherein the at least one shelf variable or rack variable is one of: shade position, top shelf position, or maximum height allowed for rack.
